(19) United States
(12) Patent Application Publication
(10) Pub. No.: US 2012/0179579 A1
(43) Pub. Date: Jul. 12, 2012

(54) CONSUMABLE SUPPLY-ORDERING SYSTEM AND IMAGE FORMING APPARATUS AND CONSUMABLE SUPPLY-ORDERING METHOD USING THE SAME

(76) Inventors: Hisashi KUNIHIRO, Osaka-shi (JP); Yasuyuki Ishiguro, Osaka-shi (JP); Hitoshi Nagahama, Osaka-shi (JP)

(21) Appl. No.: 13/344,197

(22) Filed: Jan. 5, 2012

(30) Foreign Application Priority Data
Jan. 12, 2011 (JP) 2011-004255

(51) Int. Cl. G06Q 30/06

(52) U.S. Cl. 705/26.81

(57) ABSTRACT

a The consumable supply-ordering system for ordering consumable supplies that is used an image forming apparatus that has been purchased or leased, includes: an environmental information acquisition portion (communicator) for acquiring product information on consumable supplies used in the image forming apparatus and environmental performance information on the consumable supplies; a display portion having the function of displaying product information on the consumable supplies and environmental performance information on the consumable supplies simultaneously or separately in list representation or thumbnail representation; an information selector (display screen) for selecting information displayed on the display portion; and a selection result notifier (communicator) for notifying the source of supplies of the selection result selected by the information selector.

This Nonprovisional application claims priority under 35 U. S.C. §119 (a) on Patent Application No. 2011-004255 filed in Japan on 12 Jan. 2011, the entire contents of which are hereby incorporated by reference.

### BACKGROUND OF THE INVENTION

(1) Field of the Invention

The present invention relates to a consumable supply-ordering system and an image forming apparatus and a consumable supply ordering method using this system, in particular relating to a consumable supply-ordering system and an image forming apparatus and a consumable supply ordering method using this system, for ordering consumable supplies to be used in a purchased or leased image forming apparatus.

(2) Description of the Prior Art

Recently, concerning image forming apparatuses such as copiers, facsimile machines, printers and the like, reusing and recycling of supply containers used in an image forming apparatus have been promoted to give attention to global environment.

As related art technologies, there has been a proposal in which, in accordance with an order made by a user who uses an image forming apparatus, brand-new consumable supplies are offered in exchange for the consumable supply container owned by the user, and the charge for offered ink is determined in accordance with, at least, the consumable supply-associated information indicating the model of the consumable supply container owned by the user, (Japanese Patent Application Laid-open 2002-273989). This scheme can promote reusing and recycling of consumable supply-containers. Since this also enables deduction of the charge in accordance with the remaining ink, it is possible to suppress disposal of ink and hence contribute to environmental protection.

However, according to the image forming apparatus based on the above prior art, it is possible for general users to order desired consumable supplies (ink cartridges and toner cartridge). However, there has been a problem for people of high environmental concern. That is, such people do not have any means to know the influence of consumable supplies to be ordered on the environment, hence cannot order consumable supplies that are improved in environmental performance of the image forming apparatus, from a comprehensive view point.

### SUMMARY OF THE INVENTION

The present invention has been devised in view of the above conventional problems, it is therefore an object of the present invention to provide a consumable supply-ordering system, as well as an image forming apparatus and consumable supply-ordering method using the system, which is more friendly to global environment and can provide information on environmental performance of the consumable supplies of an image forming apparatus for the users of high environmental concern.

In order to achieve the above object, the consumable supply-ordering system of the present invention, as well as the image forming apparatus and consumable supply-ordering method using the system, are configured as follows.

The present invention resides in a consumable supply-ordering system for ordering consumable supplies that are used in an image forming apparatus that has been purchased or leased, includes: an environmental information acquisition portion for acquiring product information on consumable supplies used in the image forming apparatus and environmental performance information on the consumable supplies; a display portion having the function of displaying product information on the consumable supplies and environmental performance information on the consumable supplies simultaneously or separately in list representation or thumbnail representation; an information selector for selecting information displayed on the display portion; and a selection result notifier for notifying the source of supplies (manufacturer, supplier or leasing company) of the selection result (e.g. the selected result selected by the user through the information selector) selected by the information selector.

In the present invention, it is preferably that the environmental performance information on consumable supplies includes environmental information on ecolabels that have been awarded to, authorized or certified for the consumable supplies.

In the present invention, it is preferably that the environmental performance information on the consumable supplies includes the types of greenhouse gases and the amounts of emission of the greenhouse gases with respect to the lifecycle of the consumable supplies.

In the present invention, it is preferably that the consumable supply-ordering system further includes an information display portion for displaying the product information on the consumable supplies and the environmental performance information on the consumable supplies in the display portion, and that the information display portion includes a touch panel or control keys approximately integrated with the display portion.

Further, the present invention resides in an image forming apparatus that uses the consumable supply-ordering system according to the consumable supply-ordering system above.

Moreover, the present invention reside in a consumable supply-ordering system that uses the image forming apparatus according to the image forming apparatus above.

### EFFECT OF THE INVENTION

According to the consumable supply-ordering method of the present invention, the consumable supply-ordering system for ordering consumable supplies that are used in an image forming apparatus that has been purchased or leased, includes: an environmental information acquisition portion for acquiring product information on consumable supplies used in the image forming apparatus and environmental performance information on the consumable supplies; a display portion having the function of displaying product information on the consumable supplies and environmental performance information on the consumable supplies simultaneously or separately in list representation or thumbnail representation; an information selector for selecting information displayed on the display portion; and a selection result notifier for notifying the source of supplies of the selection result (e.g. the selected result selected by the user through the information selector) selected by the information selector. Accordingly, the user can readily obtain, for example, product information on consumable supplies and environmental performance information on consumable supplies, make comparison between new consumable supplies and recycled ones based on that information, and select a consumable supply of a high environmental performance, it is hence possible to meet the demands of users of environmental concern.

Further, since the user obtains product information on consumable supplies and environmental performance information on consumable supplies, this makes the user interested in improvement of environmental concern and simulates the user to refrain from discarding the waste of consumable supplies in the same manner as general garbage. Further, it is possible for the users of high environmental concern to know the environmental performance of consumable supplies at first glance and have their needs satisfied Also, the dealer or leasing shop can readily receive orders of consumable supplies, hence this leads to improvement in sales. It is further possible to suppress the amount of emission of greenhouse gases and contribute to protection against global warming.

According to the present invention, since the environmental performance information on consumable supplies includes environmental information on ecolabels that have been awarded to, authorized or certified for the consumable supplies, the user can readily select a consumable supply easily order the consumable supply to the dealer or leasing shop when purchasing (or leasing) the consumable supply for the image forming apparatus that is currently being used.

According to the present invention, since the environmental performance information on the consumable supplies includes the types of greenhouse gases and the amounts of emissions of the greenhouse gases with respect to the lifecycle of the consumable supplies, it is possible to construct an image forming system that allows the user to grasp the environmental performance of consumable supplies and that is convenient without any remarkable degradation of total environmental performance of the image forming apparatus.

According to the present invention, the consumable supply-ordering system further includes an information display portion for displaying the product information on the consumable supplies and the environmental performance information on the consumable supplies in the display portion, and the information display portion includes a touch panel or control keys approximately integrated with the display portion. This configuration enables the user to simply display the necessary information directly from the image forming apparatus, hence easily select a consumable supply more improved in environmental performance, and readily order

Further, according to the image forming apparatus of the present invention, use of the consumable supply-ordering system according to the consumable supply-ordering system above, make it possible for the user to readily obtain product information on consumable supplies and environmental performance information on consumable supplies, make comparison between new consumable supplies and recycled ones based on that information, and select a consumable supply a high environmental performance, it is hence possible to meet the demands of users of environmental concern.

Moreover, according to the consumable supply-ordering method of the present invention, use of the image forming apparatus according to the image forming apparatus above makes it possible for the user to readily obtain product information on consumable supplies and environmental performance information on consumable supplies, make comparison between new consumable supplies and recycled ones based on that information, and select a consumable supply of a high environmental performance, it is hence possible to meet the demands of users of environmental concern.

### BRIEF DESCRIPTION OF THE DRAWINGS

FIG. 1 is an illustrative diagram showing an overall configuration of an image forming apparatus according to the embodiment of the present invention;

FIG. 2 is a block diagram showing the configuration of the image forming apparatus;

FIG. 3 is an illustrative diagram showing a configuration of a control panel that constitutes a consumable supply-ordering system for the image forming apparatus;

FIG. 4 is an illustrative diagram showing an initial screen on a display portion of the control panel;

FIG. 5 is an illustrative diagram showing one example of a display on a display portion of the control panel, displaying product information on toner cartridges in list representation and ecolabel information as environmental performance information on toner cartridges in thumbnail representation;

FIG. 6 is an illustrative diagram showing one example of a displayed state when one item is selected from the list of product information on toner cartridges and thumbnails of ecolabel information as environmental performance information on toner cartridges;

FIG. 7 is an illustrative diagram showing one example of a communication network that enables acquisition of environment measure information on consumable supplies from the consumable supply-ordering system of the image forming apparatus and ordering of consumable supplies; and,

FIG. 8 is a flow chart showing the procedures when a consumable supply is ordered by the consumable supply-ordering system of the image forming apparatus.

### DESCRIPTION OF THE PREFERRED EMBODIMENTS

The mode for carrying out the present invention will hereinafter be described in detail with reference to the accompanying drawings.

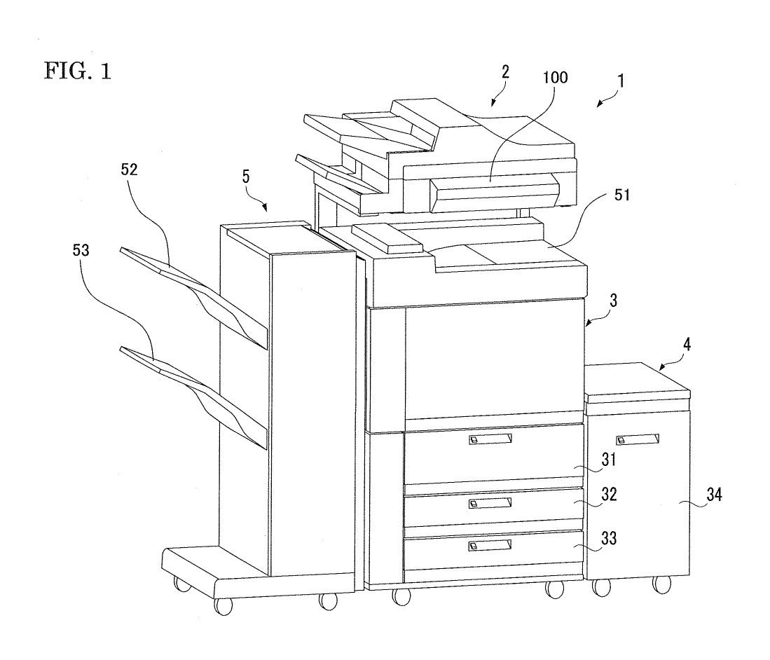

FIG. 1 is an illustrative diagram of one exemplary mode of the present invention, showing an overall configuration of an image forming apparatus according to the embodiment of the present invention.

As shown in FIG. 1, the present embodiment is a consumable supply-ordering system used for an image forming apparatus 1 that forms images with toner based on electrophotography, to which a consumable supply-ordering system of the present invention is applied.

To being with, the overall configuration of image forming apparatus 1 will be described.

Image forming apparatus 1 forms an image on a predetermined sheet (recording paper, recording medium) in accordance with image data transferred from without. As shown in FIG. 1, image forming apparatus 1 is essentially composed of an image forming portion 3 as the main apparatus having an electrophotographic processor (not shown) and an image reader 2 having a scanner unit (not shown).

Image data obtained by scanning a document image with a scanner unit is subjected to various processes, then is temporarily stored in a memory. In response to an output direction, the image data is output from the memory to image forming portion 3 so as to reproduce a visual image as a toner image on a photoreceptor drum (not shown). Then the toner image is transferred to the paper to form printed image.

A paper feed portion 4 for supply paper is arranged next to image forming portion 3.

Paper feed portion 4 includes a first to third cassettes 31, 32 and 33, and a high volume cassette 34 as an option. High volume cassette 34 can store a large volume of the most commonly used paper, i.e., A4 sized standard paper.

Formed between image reader 2 and image forming portion 3 is a paper output tray 51.

A post-processor 5 is arranged next to image forming apparatus 3.

Post-processor 5 is equipped with a first output tray 52 and second output tray 53.

Image forming apparatus 1 is connected to PCs and a FAX via unillustrated network lines (LAN, telephone line, etc.)

Now, the configuration of image forming apparatus 1 will be described with reference to a block diagram.

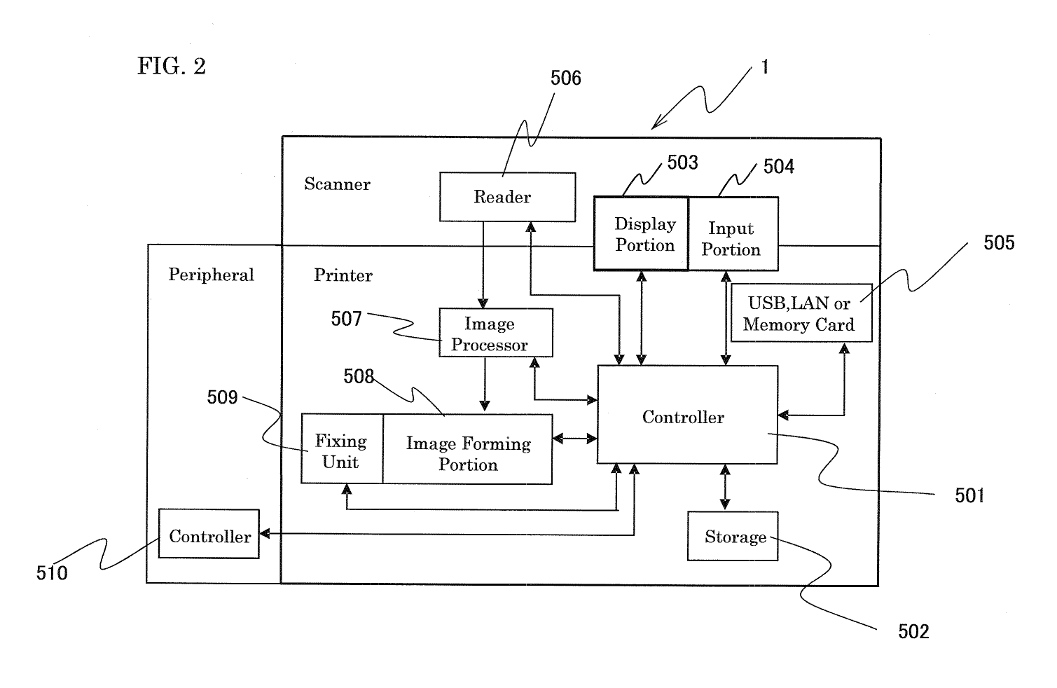

FIG. 2 is a block diagram showing a configuration of the image forming apparatus of the present embodiment.

As shown in FIG. 2, image forming apparatus 1 includes, as electric components, a controller 501 for controlling the operation of image forming apparatus 1, a storage 502, a display portion 503, an input portion 504, a communicator 505 that establishes LAN connection and the like with PCs and the like via a network line, an image processor 507 for performing image processing, an image forming portion 508 for performing image forming, fixing unit 509 for performing a fixing process of toner images, a reader 506 for reading images by a scanner and a controller 510 for controlling the operation of post-processing apparatus 5 (indicating the peripheral in FIG. 2).

Next, the consumable supply-ordering system characterized in image forming apparatus 1 of the present embodiment will be described with reference to the drawings,

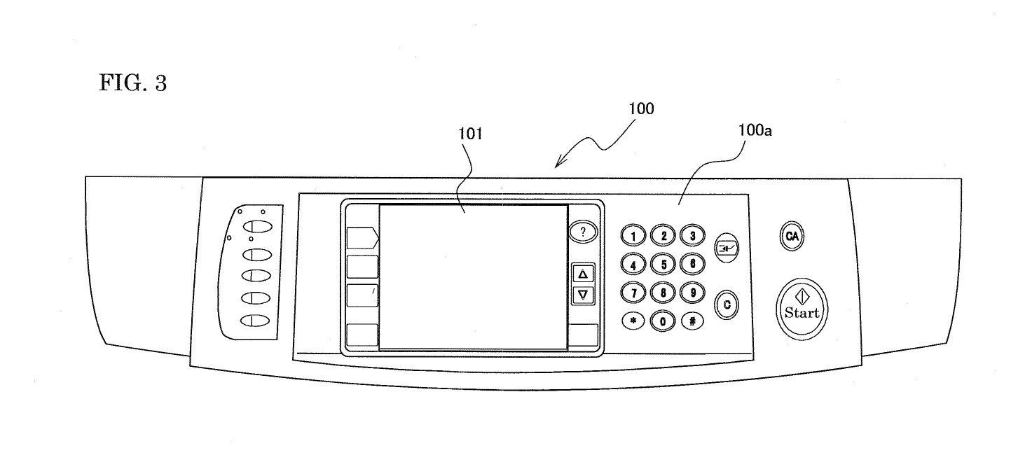

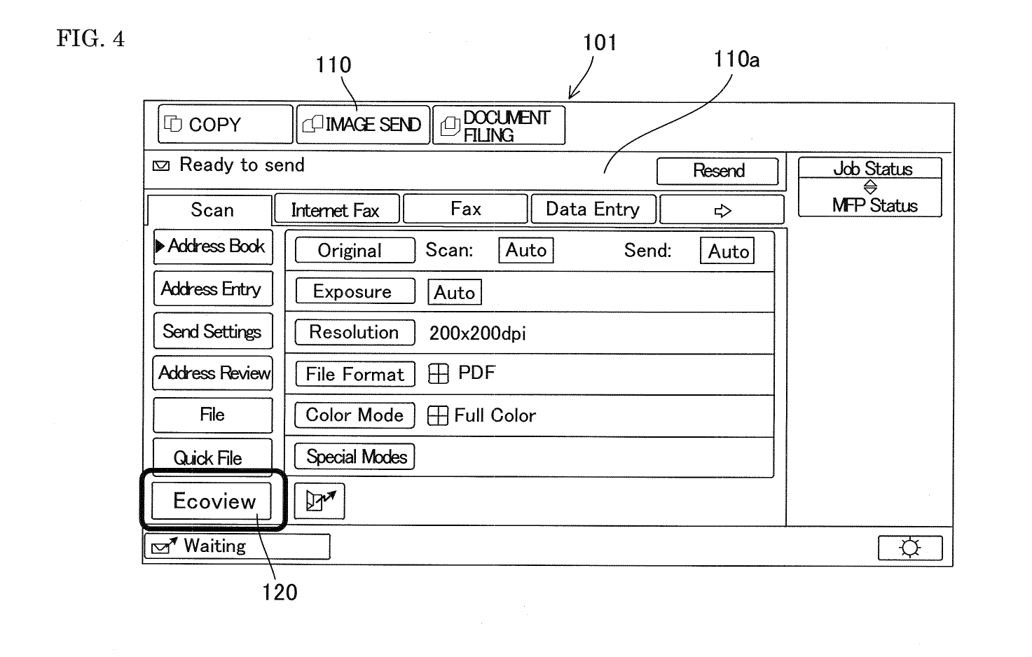

FIG. 3 is an illustrative diagram showing a configuration of a control panel that constitutes the consumable supply-ordering system for the image forming apparatus of the present embodiment. FIG. 4 is an illustrative diagram showing an initial screen on the display portion of the control panel.

The consumable supply-ordering system of image forming apparatus 1 according to the present embodiment is a system for ordering consumable supplies to be used in image forming apparatus 100 to the manufacturer, supplier or leasing company by the control on control panel 100.

This consumable supply-ordering system includes: an environment information acquisition unit for acquiring product information on consumable supplies to be used in image forming apparatus 1, e.g., toner cartridges and environment performance information as to the toner cartridges; a display portion having a function of displaying product information on toner cartridges and environmental performance information on toner cartridges at the same time or separately in list representation or thumbnail representation; an information. selector for selecting information displayed on the display portion; and a selection result notifier for giving notice of the result of selection selected by the information selector to the source of supplies.

In the present embodiment, display portion 101 of control panel 100 is adapted to function as the display portion of the consumable supply-ordering system.

As shown in FIGS. 3 and 4, control panel 100 has a control surface (input portion) 100a given in an approximately flat form, in which display portion 101 is arranged in the approximate center.

Display portion 101 is displayed with control keys 110 for selecting a processing mode of image forming apparatus 1. Use of control keys 110 makes it possible to select COPY mode, IMAGE SEND mode or DOCUMENT FILING mode.

When image forming apparatus 1 is activated, an unillustrated initial screen is displayed on display portion 101. As IMAGE SEND mode is selected by its control key 110, IMAGE SEND initial screen 110a is displayed as shown in FIG. 4.

An Ecoview icon 120 is displayed in the lower left of IMAGE SEND initial screen 110a. When Ecoview icon 120 is touched, product information on consumable supplies to be used in image forming apparatus 1 and environmental performance information as to consumable supplies (e.g., the ecolabels that have been awarded to or authorized for the consumable supplies) are displayed in list representation or thumbnail represented on display portion 101.

Control panel 100 has an icon (not shown) for selecting list representation or thumbnail representation and an icon (not shown) for recovering IMAGE SEND mode initial screen 110a.

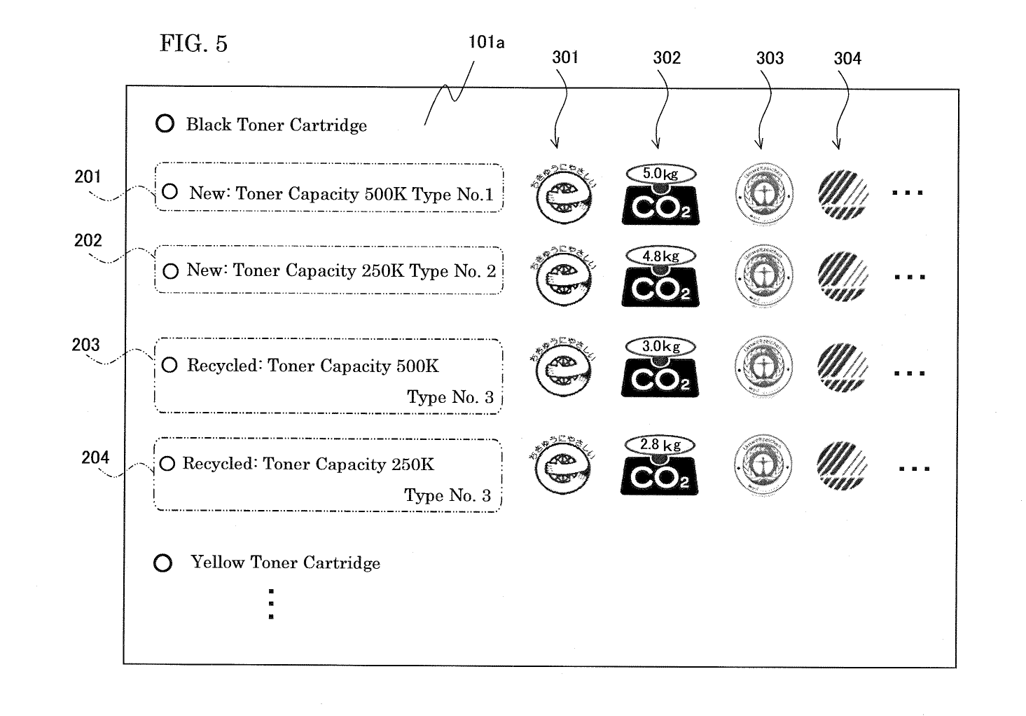

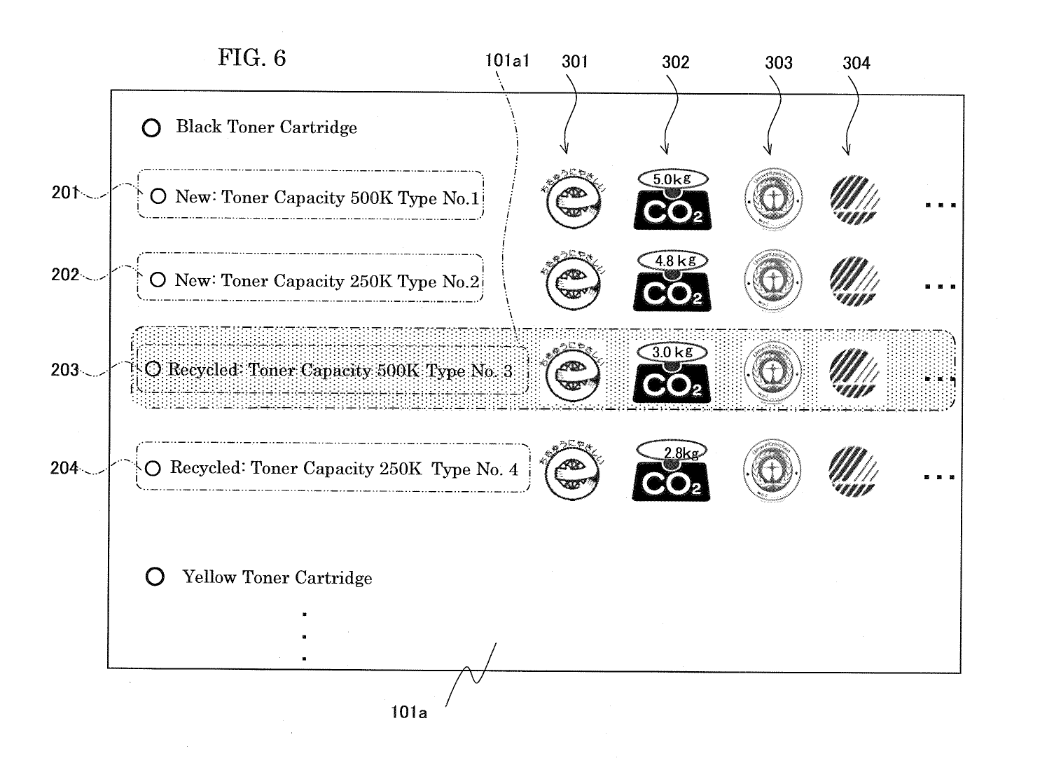

Further, in the present embodiment, as shown in FIGS. 5 and 6, the list of product information on consumable supplies and thumbnails of environmental performance information on consumable supplies displayed on display screen 101a are configured so that the list representation or thumbnail representation displayed on the screen will function as an information selector of the associated information when touching them through a touch panel, for example. That is, display screen 101a itself functions an information selector.

Further, in the present embodiment, communicator 505 in image forming apparatus 1 is configured so as to provide both the function as an environmental information acquisition unit for acquiring product information on consumable supplies and environmental performance information on consumable supplies from the manufacturer, supplier or leasing company, via a network line and the function as a selection result notifier for notifying the result of selection selected by the information selector to the source of supplies.

Now, by taking toner cartridges as the example of the consumable supplies displayed on display portion 101 of control panel 100 in the present embodiment, the list representation of product information on toner cartridges and thumbnail representation of environmental ecolabel information as the environmental performance information on toner cartridges will be described in detail with reference to the drawing.

FIG. 5 is an illustrative diagram showing one example of the list representation of the product information on toner cartridges and thumbnail representation of environmental ecolabel information as the environmental performance information on toner cartridges, displayed on the display portion of the control panel of the present embodiment. FIG. 6 is an illustrative diagram showing one example of a displayed state when one item is selected from the list of product information on toner cartridges and thumbnails of ecolabel information as environmental performance information as to toner cartridges.

In the present embodiment, as shown in FIG. 5, display portion 101 displays the list representation of product information on toner cartridges and thumbnail representation of environmental ecolabel information on toner cartridges, at the same time on display screen 101a.

Specifically, on display screen 101a as shown in FIG. 5, the list of product information on toner cartridges of different color toners and the thumbnails of environmental information on ecolabels that have been awarded to, authorized or certified for respective toner cartridges.)

In the present embodiment, as the list of toner cartridges, for example, the display of black toner cartridges includes: type No. 1 designated by product information 201, new toner cartridge with toner capable of printing 500 K sheets; type No. 2 designated by product information 202, new toner cartridge with toner capable of printing 250 K sheets; type No. 3 designated by product information 203, recycled toner cartridge with toner capable of printing 500 K sheets; and type No. 4 designated by product information 204, recycled toner cartridge with toner capable of printing 250 K sheets.

Here, “toner capable of printing 500 K sheets” indicates the amount of toner equivalent to the number of sheets the cartridge can print out when a standard original (A4size) with 4% coverage is used.

In correspondence to each toner cartridge, environmental information on the obtained, authorized or certified ecolabels for the toner cartridge is shown, including thumbnail 301 of EcoMark (registered trademark), thumbnail 302 of carbon footprint label, thumbnail 303 of the Blue Angel, thumbnail 304 of Nordic Swan (registered trademark) and the like.

EcoMark (registered trademark) is based on Japan standards confirming to the ISO standards, and is awarded to products that contribute to environmental protection, taking account various influences on environment during their entire lifecycle.

The carbon footprint label displays the amount of greenhouse gas emission in the entire lifecycle as CO₂ equivalent by using LCA (Lifecycle Assessment) technique to quantitatively calculate environmental impacts of a product or service with all the stages of the product or service's life from raw material procurement to disposal or recycling).

The Blue Angel is a Germany ecolabel for products and services and is one of important indexes that inform the user of environmentally friendly products or enterprise attitudes toward environment, and are awarded to a product or the like that is excellent in energy saving etc., not only based on the evaluation on influences of all the stages to environment from production of the product to disposal, but also based. on the comparison with other products having the same purpose and function, and still guaranteed as to its availability and safety. The Nordic swan (registered tradename) is an ecolabel based on the official ecolabel system of the Nordic countries.

Each of the list representation of product information of cartridges and the thumbnail representation of environmental ecolabel information displayed on display screen 101a is constructed so as to function as an information selector to allow the user to select the information by touching the entry on the screen through, for example a touch panel.

Next, a case of selecting and ordering a toner cartridge to be used for image forming apparatus 1 of the present invention will be described.

In the present embodiment, when, for example, a toner cartridge related to product information 203 is ordered, the toner cartridge the user wants is selected by touching product information 203 displayed on display screen 101a in FIG. 5, or the environmental information on ecolabels (thumbnail 301 of ecomark (registered trademark), thumbnail 302 of carbon foot print label, thumbnail 303 of the Blue Angle, thumbnail 304 of the Nordic Swan (registered trademark), and the like) that have been awarded to, authorized or certified for the toner cartridge.

When the user touches the list representation of the product information of toner cartridge or the thumbnail representation of environmental ecolabel information on display screen 101a, information displayed area 101a1 in which product information 203 of the toner cartridge and the thumbnail of environmental ecolabel information of the toner cartridge are displayed, changes in color (or is highlighted) so as to make clear that the toner cartridge related to product information 203 has been selected.

The change of display between the chosen toner cartridge and the unchosen toner cartridges should not be limited to the above-described mode, but may be done by changing the list representation or thumbnail representation of the chosen cartridge into inconspicuous color, or changing them in color tone or in size of the pattern and text. As another example, it is possible to provide an area to display the type number of the selected cartridge at a predetermined position on display portion 101 and display the type number of the selected toner cartridge in that area. It is also possible to configure the system so that the above toner cartridge selection can be continuously operated.

According to the present embodiment, product information on toner cartridges is displayed on display portion 101 of control panel 100 together with environmental ecolabel information so that the user can select the toner cartridge the user wants, on the screen based on the displayed information. Accordingly, it is possible for the user to easily order the toner cartridge, taking its environmental performance into consideration.

That is, the user of high environmental concern can easily know the amount of CO₂ emission equivalents associated with the user's usage, maintenance, from the displayed content of carbon footprint label corresponding to each toner cartridge displayed on display portion 101, as shown in FIGS. 5 and 6.

The weight (kg) indicated in the mark of the carbon footprint label shown in FIG. 6 shows the total amount of CO₂ emission equivalents from raw material procurement to disposal/recycling in the lifecycle stage of each toner cartridge.

In the case of the present embodiment, the carbon footprint label corresponding to the toner cartridge type number is added with the amount of CO₂ emission so that the user can select the most suitable toner cartridge by considering the amounts of CO₂ emissions as well as the capacity of toner cartridges, and hence can have the satisfaction of contributing to protection against global warming.

Further, if the dealer of the consumable supplies of image forming apparatus 1 tires to recommend the toner cartridge whose CO₂ emission equivalent from raw material procurement to disposal/recycling in its lifecycle stage is lower than others, this leads to sale promotion of the toner cartridge for the dealer.

Here, the information in the lifecycle of a toner cartridge includes information on the kinds of greenhouse gases and the amounts of their emissions from the procurement stage of raw materials of the toner cartridge through production, distribution, use and maintenance, and disposal or recycling.

Though there are six kinds of greenhouse gases that were targeted by the Kyoto Protocol, namely CO₂, CH₄, N₂O, HFCs, PFCs and SF₆, the total amount of CO₂ equivalents is recorded on the label, so that the CO₂ equivalent of the toner cartridge is displayed on the Ecoview thumbnail representation.

The amount of CO₂ emission is calculated by the following general formula (I), based on the LCA (Lifecycle Assessment) technique.

The amount of CO₂ emission=(quantity of activity i×unit CO₂ emission) (I),

where i is the quantity of activity (process) from procurement of raw materials to disposal or recycling.

(1) to (5) show respective stages in the lifecycle with their examples of the quantities of activity (process).
(1) The quantity of activity in the raw material procurement stage is the quantity of raw materials consumed.
(2) The quantity of activity in the production stage is the weight of assembly and the amount of power consumption during production.
(3) The quantity of activity in the distribution stage is the transport volume (the product of the transport distance, the load factor and the load of the transport vehicle)
(4) The quantity of activity in the use and maintenance stage is the amount of power consumption during usage.
(5) The quantity of activity in the disposal/recycling stage is the weight of land filling and the weight of recycling.

Here, the unit of the amount of CO₂ emission is (kg)

Accordingly, the text of CO₂ and information on the amount of CO₂ emission (kg) are written on the label.

The unit of the amount of CO₂ emission may use weight units such as (g) and (t) other than (kg)

It is also possible to put a written explanation for explaining the carbon footprint mark.

It is also possible to display various pieces of ecolabel information other than the information in the lifecycle of the toner cartridge. Those may be either legal marks and commercial marks. Further, it is also possible to display a new mark if a new environmental standard is established, following the trend of time.

Further, though awarded environmental labels or authorized environmental labels are different depending on countries and areas, the present invention can be adapted to any countries or areas.

Next, the operation of ordering a consumable supply by means of the consumable supply-ordering system for image forming apparatus 1 of the present embodiment will be described.

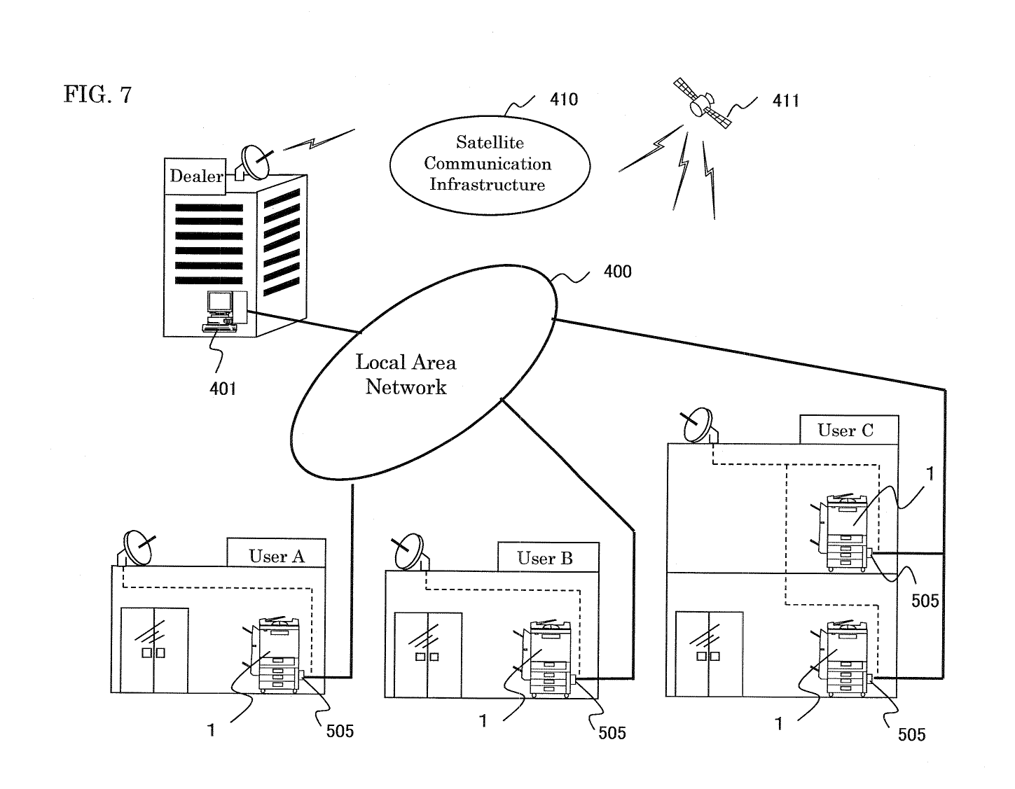

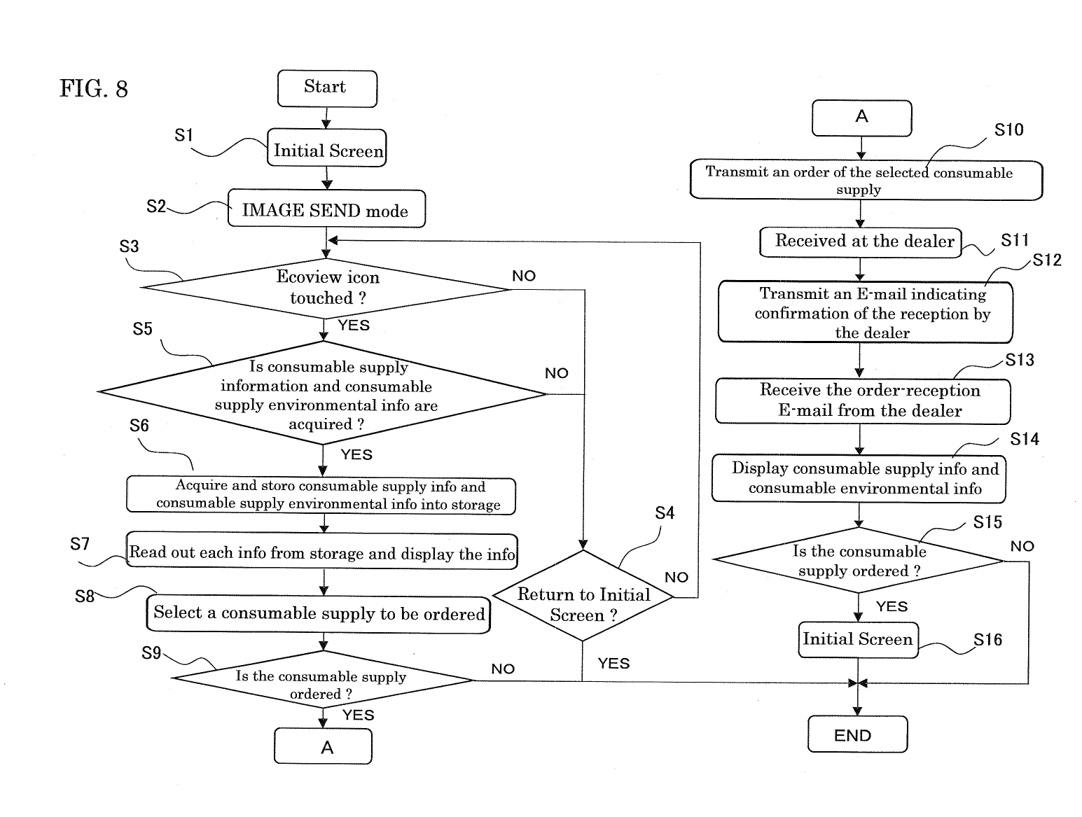

FIG. 7 is an illustrative diagram showing one example of a communication network that enables the user to acquire environment measure information on consumable supplies from the consumable supply-ordering system of the image forming apparatus of the present embodiment and to order consumable supplies. FIG. 8 is a flow chart showing the procedures when a consumable supply is ordered by the consumable supply-ordering system of the image forming apparatus.

In the present embodiment, the whole control of image forming apparatus 1 is carried out by controller 501, as shown in FIG. 2. The product information on toner cartridges of image forming apparatus 1 and ecolabel information as the environmental measure information on toner cartridges have been stored in storage 502.

Storage 502 may be a HDD drive, Blue-ray disk drive, ROM, RAM, or memory device such as a USB memory stick and memory card.

The environmental ecolabel information on toner the manufacture, dealer, leasing company, or the like, having the environmental ecolabel information of toner cartridges, via a network by LAN connection through communicator 505.

For example, as shown in FIG. 7, multiple users A, B and C, each having image forming apparatus 1 as the terminal thereof, can access a server 401 a supplier, leasing company or the like via a LAN (local area network) or via satellite communication infrastructure using a communication satellite 411, by means of communicator 505 thereof.

As LAN (local area network) 400, for a wired network, 10BASE-T, 100BASE-TX, 10GBASE-T Ethernet (registered trademark) and the like based on the IEEE standard, 10BASE-F, 100BASE-F, 1000BASE-X, 10GBASE-R, 10GBASE-W and 10GBASE-X as their optical mode may be used. For a wireless network, WiMAX IEEE 802.16 (broadband wireless access standard), IEEE 802.16a (fixed wireless communication standard by changing the use frequency of the IEEE 802.16 standard), IEEE 802.16-2004 (a scheme used for a fixed section, another name: IEEE 802.16a/REVd), WAN and Cloud computing service (dedicated operator: cloud provider) can also be used.

Next, the operation steps of a case where a consumable supply is ordered in image forming apparatus 1 using the consumable supply-ordering system of image forming apparatus 1 will be described following a flow chart.

As shown in FIG. 8, when power to image forming apparatus 1 is turned on, an unillustrated initial screen is displayed (Step S1). In the initial screen, IMAGE SEND mode is selected by means of control keys 110 for selecting a processing mode in image forming apparatus 1, so that IMAGE SEND mode is executed (Step S2). At this time, display portion 101 displays IMAGE SEND initial screen 110a.

Then, it is determined whether Ecoview icon 120 displayed on IMAGE SEND initial screen 110a is touched or not (Step S3).

At Step S3, when it is determined that Ecoview icon 120 is not touched, the control goes to Step S4, where it is determined whether the control should be returned to initial screen 110a. It is determined at Step S4 that the control returns to initial screen 110a, the operation returns to initial screen 110a and the ordering process is ended. When, at Step S4, it is determined that the control does not return to initial screen 110a, the operation returns to Step S3, once again.

On the other hand, at Step S3, when it is determined that Ecoview icon 120 is touched, the control goes to Step S5, where it is determined whether product information on consumable supplies and consumable supply environmental information should be acquired.

It is determined at Step S5 that product information on consumable supplies and consumable supply environmental information are not obtained, the control goes to S4, where it is determined whether the control should be returned to initial screen 110a. It is determined at Step S4 that the control retunes to initial screen 110a, the operation returns to initial screen 110a and the ordering process is ended. When, at Step S4, it is determined that the control does not return to initial screen 110a, the operation returns to Step S3, once again.

When it is determined at Step S5 that product information on consumable supplies and consumable supply environmental information are obtained, the image forming apparatus accesses the website of the manufacture, sales company, sales agency, leasing company or the like having ecolabel information of image forming apparatus 1 via the network by means of the LAN connection through communicator 505 to transmit a request mail for requesting transmission of consumable supply product information and consumable supply environmental information and thereby obtain the consumable supply product information and consumable supply environmental information. Then, the obtained consumable supply product information and consumable supply environmental information are stored into storage 502 (Step S6).

The mail address of the manufacture, sales company, sales agency, leasing company or the like of image forming apparatus 1 so that the request mail is automatically transmitted to the above mail address when acquisition of consumable supply product information and consumable supply environmental information is selected.

The request mail to the manufacture, sales company, sales agency, leasing company or the like may be set up to automatically include the name and model number and the like of the image forming apparatus 1, and the sales company the like having received the transmitted request mail may transmit the consumable supply product information and consumable supply environmental information to the user based on the name, model number and the like of the image forming apparatus 1. This may either be manually transmitted or may be set up so as to be automatically transmitted.

Here, the reason why the consumable supply product information and consumable supply environmental information are once stored into storage 502 is that this makes it possible to select and order a consumable supply by retrieving the consumable supply product information and consumable supply environmental information from storage 502 without the need of requesting the consumable supply product information and consumable supply environmental information, more than once, hence has the merit of reducing communication cost.

After Step S6, the consumable supply product information and consumable supply environmental information stored in storage 502 are read out and displayed on display portion 101 in list representation and thumbnail representation (Step S7). Then, the user confirms the consumable supply product information and consumable supply environmental information given on display portion 101 in list representation and thumbnail reprehension, and touches the wanted consumable supply from the list a representation or the thumbnail representation displayed in display portion 101 to select (Step S8).

Then, it is determined whether the selected consumable supply is ordered or not (Step S9).

It is determined at Step S9 that the consumable supply is not ordered, the consumable supply ordering process is ended. On the other hand, it is determined at Step S9 that the consumable supply is ordered, an ordering direction of the selected consumable supply is transmitted from communicator 505 of image forming apparatus 1 to the manufacture, sales company, sales agency, leasing company or the like (it is assumed in this case that the direction is transmitted to a dealer) having ecolabel information of the toner cartridge via the network (Step S10).

For example, when a consumable supply wanted to be ordered (the consumable supply product information and consumable supply environmental information given in list representation or thumbnail representation) is selected on display portion 101 and an unillustrated transmit icon is selected, the ordering mail and format are automatically changed so that a mail or FAX is transmitted to the dealer or the like.

It is noted that the change of the ordering mail and format may be automatically performed by the linkage of the consumable supply selection and the transmit icon.

When the order of the consumable supply is received at the dealer (Step S11), a mail in confirmation of reception of the order of the consumable supply is transmitted from the dealer (Step S12).

When the image forming apparatus 1 receives the confirmation mail of reception of ordering from the dealer (Step S13), the product information on the consumable supply and consumable supply environmental information is displayed once again in list representation and thumbnail representation on display portion 101 of control panel 100 (Step S14).

Then, it is determined whether a consumable supply needs to be ordered (Step S15). If it is determined that no consumable supply is ordered, the ordering process of consumable supplies is ended. On the other hand, if it is determined at Step S15 that a consumable supply is ordered, the control returns to the initial screen for selecting a processing mode of image forming apparatus 1 (Step S16) and the ordering process of consumable supplies is ended. The above ordering process may be carried out during the period from the start of warm-up of the image forming apparatus up to the printable Ready state, or during an interval between printing jobs. Performing the ordering process during either of these periods is effective, for example in avoiding interference with the use of the image forming apparatus by another user.

As configured heretofore, according to the present embodiment, the consumable supply-ordering system of image forming apparatus 1 includes: a display portion made to function by means of display portion 101 of control panel 100; an information selector for selecting information, by displaying the list representation of product information on consumable supplies and thumbnail representation of the environmental performance information on consumable supplies on display screen 101a displayed on display portion 101 and allowing the user to touch and select the list representation of product information on consumable supplies and thumbnail representation of the environmental performance information on consumable supplies, displayed on display screen 101a, via a touch panel; an environmental information acquisition portion, that is made to function by communicator 505 in image forming apparatus 1, for acquiring product information on consumable supplies and environmental performance information on consumable supplies from a manufacturer, supplier, or leasing company via a network line; and a selection result notifier for notifying the source of supplies of the result of selection selected by the information selector. With this configuration, it is possible for the user to readily obtain product information on consumable supplies and environmental performance information on consumable supplies, make comparison between new consumable supplies and recycled ones, for example, and select a consumable supply of a high environmental performance, whereby it is possible to meet the demands of users of environmental concern, and hence contribute to protection against global warming.

Though in the present embodiment, Ecoview icon 120 is provided on display portion 101 so as to provide a display switching function, it is also possible to provide an Ecoview operation key in other than display portion 101 if the screen is small in size and the control portion (menu key, ten keys and print key, etc.) is small so that there is no space for the Ecoview icon on the screen. Further, though in the present embodiment, Ecoview icon 120 is arranged at the lower right in display portion 101, the position is not particularly limited, and the icon may be arranged at any position, the top, bottom, left or right in display portion 101.

The above embodiment was described taking an example in which the consumable supply-ordering system according to the present embodiment is applied to control panel 100 of image forming apparatus 1 shown in FIG. 1. However, the present invention should not be limited to image forming apparatuses and copiers as described above, and can be applied to other apparatuses such as household appliances, consumer appliances (indicating electronic appliances and devices associated with video, audio and communication and the like, or terminals that are aimed at use of general consumers in ordinary families, or that are products and specifications developed and designed based on that premise), appliances for business use (products developed on the premise of usage other than ordinary families, such as in corporations (enterprises, schools, public agencies) and the like) and others.

Here, though a touch panel is used as input portion 504, a gesture-input device using a Ubi-Finger device and the like may be used.

Further, the present invention can be applied to personal computers, mobile information terminals or electronic appliances including a liquid crystal display, organic EL display, plasma display, plasma tube array display, electronic paper display using electrophoresis or display using electron emitting device (FED, SED), which are connected to image forming apparatus 1 of the present embodiment via LAN 400 and can control image forming apparatus 1.

Having described heretofore, the present invention is not limited to the above embodiment, various changes can be made within the scope of the appended claims. That is, any embodied mode obtained by combination of technical means modified as appropriate without departing from the spirit and scope of the present invention should be included in the

What is claimed is:

1. A consumable supply-ordering system for ordering consumable supplies that are used in an image forming apparatus that has been purchased or leased, the consumable supply-ordering system comprising:
an environmental information acquisition portion for acquiring product information on consumable supplies used in the image forming apparatus and environmental performance information on the consumable supplies;
a display portion having the function of displaying product information on the consumable supplies and environmental performance information on the consumable supplies simultaneously or separately in list representation or thumbnail representation;
an information selector for selecting information displayed on the display portion; and
a selection result notifier for notifying the source of supplies of the selection result selected by the information selector.

2. The consumable supply-ordering system according to claim 1, wherein the environmental performance information on consumable supplies includes environmental information on ecolabels that have been awarded to, authorized or certified for the consumable supplies.

3. The consumable supply-ordering system according to claim 1, wherein the environmental performance information on the consumable supplies includes types of greenhouse gases and an amount of emission of the greenhouse gases with respect to a lifecycle of the consumable supplies.

4. The consumable supply-ordering system according to claim 1, further comprising an information display portion for displaying the product information on the consumable supplies and the environmental performance information on the consumable supplies in the display portion, wherein the information display portion includes a touch panel or control keys approximately integrated with the display portion.

5. An image forming apparatus characterized in that the consumable supply-ordering system according to claim 1 is used.

6. A consumable supply-ordering method characterized in that the image forming apparatus according to claim 5 is used.
